(19) United States
(12) Patent Application Publication
(10) Pub. No.: US 2006/0181479 A1
(43) Pub. Date: Aug. 17, 2006

(54) Filter assembly and method of filtering electromagnetic radiation

(76) Inventors: Joseph V. Mantese, Shelby Township, MI (US); Andrzej M. Pawlak, Rochester Hills, MI (US)

Correspondence Address: DELPHI TECHNOLOGIES, INC., M/C 480-410-202, PO BOX 5052, TROY, MI, 48007, US

(21) Appl. No.: 11/353,355

(22) Filed: Feb. 14, 2006

Related U.S. Application Data
(60) Provisional application No. 60/653,261, filed on Feb. 15, 2005.

(51) Int. Cl. H01Q 15/02

(52) U.S. Cl. 343/909

(57) ABSTRACT

A filter assembly and a method for filtering electromagnetic radiation are provided. The filter assembly includes a dielectric layer having a first side and a second side. The filter assembly further includes a first conductive layer disposed on the first side of the dielectric layer. The filter assembly further includes a second conductive layer disposed on the second side of the dielectric layer. The filter assembly further includes a voltage source electrically coupled to the first and second conductive layers. The voltage source is configured to generate a first voltage signal that adjusts a dielectric constant value of the dielectric layer to a first desired dielectric constant value to filter electromagnetic radiation impinging on the first conductive layer. The voltage source is further configured to generate a second voltage signal that adjusts the dielectric constant value of the dielectric layer to a second desired dielectric constant value to filter electromagnetic radiation impinging on the first conductive layer.

### CROSS REFERENCE TO RELATED APPLICATIONS

The application claims the benefit of U.S. Provisional application, Ser. No. 60/653,261, filed Feb. 15, 2005, the contents of which are incorporated herein by reference thereto.

### TECHNICAL FIELD

This application relates to a filter assembly and a method for filtering electromagnetic radiation.

### BACKGROUND

An infrared sensor has been developed which generates an output voltage in response to electromagnetic radiation contacting the infrared sensor. Further, optical filters have been disposed between an imaging area emitting electromagnetic radiation and infrared sensors to only allow electromagnetic radiation having a particular wavelength to pass through the optical filter to contact the infrared sensor.

A disadvantage with the optical filter is that the optical filter has a fixed response (e.g. fixed absorption, reflection, or rejection response) due to a fixed dielectric constant. The fixed dielectric constant induces the optical filter to only allow electromagnetic radiation having a selected wavelength to pass therethrough, be reflected therefrom, or be absorbed therein.

Accordingly, there is a need for an improved filter that is configured to vary the dielectric constant of a layer therein.

### SUMMARY

A filter assembly for filtering electromagnetic radiation in accordance with an exemplary embodiment is provided. The filter assembly includes a dielectric layer having a first side and a second side. The filter assembly further includes a first conductive layer disposed on the first side of the dielectric layer. The filter assembly further includes a second conductive layer disposed on the second side of the dielectric layer. The filter assembly further includes a voltage source electrically coupled to the first and second conductive layers. The voltage source is configured to generate a first voltage signal that adjusts a dielectric constant value of the dielectric layer to a first desired dielectric constant value to filter electromagnetic radiation impinging on the first conductive layer. The voltage source is further configured to generate a second voltage signal that adjusts the dielectric constant value of the dielectric layer to a second desired dielectric constant value to filter electromagnetic radiation impinging on the first conductive layer.

A method for filtering electromagnetic radiation utilizing a filter assembly in accordance with another exemplary embodiment is provided. The filter assembly has a dielectric layer having a first side and a second side. The filter assembly further includes a first conductive layer disposed on the first side of the dielectric layer. The filter assembly further includes a second conductive layer disposed on the second side of the dielectric layer. The filter assembly further includes a voltage source electrically coupled to the first and second conductive layers. The method comprises generating a first voltage signal utilizing the voltage source that adjusts a dielectric constant value of the dielectric layer to a first desired dielectric constant value to filter electromagnetic radiation impinging on the first conductive layer. The method further comprises generating a second voltage signal utilizing the voltage source that adjusts the dielectric constant value of the dielectric layer to a second desired dielectric constant value to filter electromagnetic radiation impinging on the first conductive layer. dr

### BRIEF DESCRIPTION OF THE DRAWINGS

FIG. 1 is a block diagram of an electromagnetic radiation detection system having a focal plane array and a filter array in accordance with an exemplary embodiment;

FIG. 2 is a top view of the focal plane array shown in FIG. 1;

FIG. 3 is a cross-sectional view of a filter device in the filter array shown in FIG. 1; and

FIG. 4 is a graph of a tunability curve associated with the filter device of FIG. 3.

### DESCRIPTION OF EXEMPLARY EMBODIMENTS

Referring to FIG. 1, an electromagnetic radiation detection system 10 for generating images based upon received electromagnetic radiation is provided. The system 10 includes a focal plane array 12, a filter array 14, a filter controller 16, a focal plane array controller 18, and an image processor 20. For purposes of understanding, the terms “to filter” means to allow electromagnetic radiation to (i) pass therethrough, (ii) be reflected therefrom, or (iii) be absorbed therein.

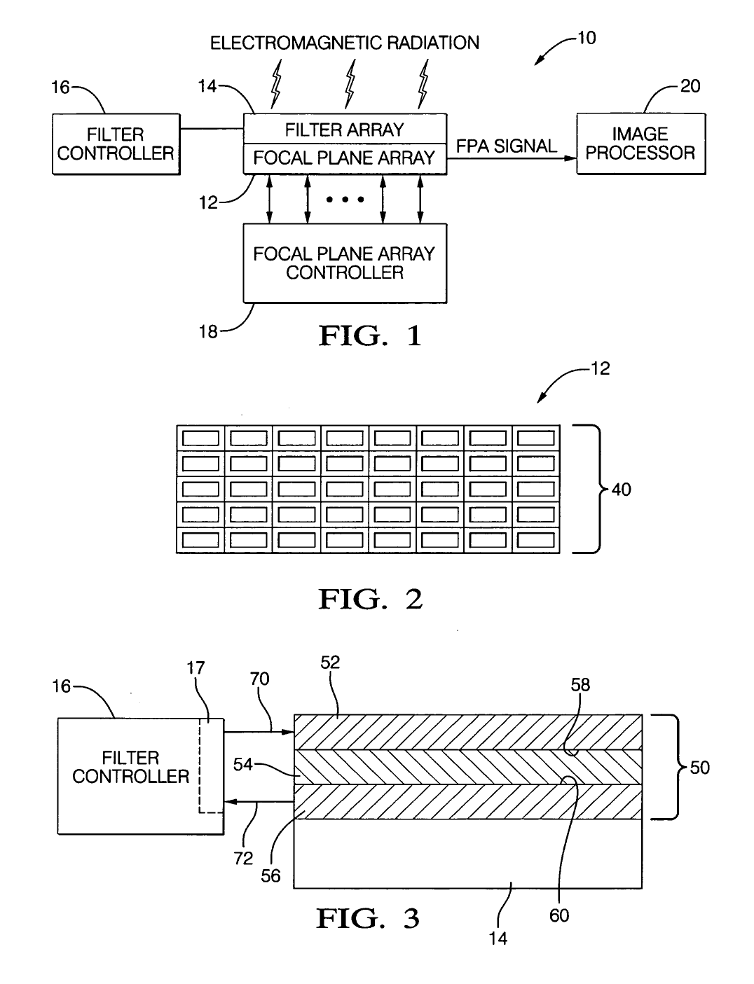

Referring to FIGS. 1 and 2, the focal plane array 12 is provided to generate an FPA signal based upon electromagnetic radiation impinging upon the focal plane array 12. The FPA signal is utilized by the image processor 20 to generate a digital image. The focal plane array 12 can be utilized in a wide range of applications including imaging in low visibility conditions, such as poor weather conditions or at night. The focal plane array 12 comprises a plurality of pyroelectric sensors 40. Each pyroelectric sensor of the plurality of pyroelectric sensors 40 has a substantially similar structure known to those skilled in the art. It should be noted that in alternate embodiments, other types of sensors known to those skilled in the art could be utilized instead of the pyroelectric sensors, such as silicon-based sensors for example. The focal plane array 12 operably communicates with the focal plane array controller 18 that controls operation of the focal plane array 12.

The optical filter array 14 is provided to filter electromagnetic radiation, such as visible light or infrared light for example, the impinge on the filter array 14. For example, the filter array 14 is configured to: (i) reflect electromagnetic radiation the contacts the filter array 14, (ii) absorb electromagnetic radiation that impinges on the filter array 14, or (iii) allow electromagnetic radiation impinging on the filter array 14 to pass therethrough to the focal plane array 12. The filter array 14 comprises a plurality of filter assemblies 50, wherein each filter assembly 50 is deposited over a corresponding pyroelectric sensor 40.

Referring to FIG. 3, the structure of one filter assembly 50 will now be described. The filter assembly 50 includes a conductive layer 52, a dielectric layer 54, and a conductive layer 56. The conductive layer 52 is operably coupled to a side 58 of the dielectric layer 54. Further, the conductive layer 56 is operably coupled to a side 60 of the dielectric layer 54. The conductive layers 52, 56 are electrically coupled via conductive lines 70, 72, respectively to the filter controller 16. The dielectric layer 54 is constructed from one or more ferroelectric materials. Ferroelectric materials include, but are not limited to, barium titanate, barium strontium titanate, strontium bismuth tantalate, lead zirconate titanate (and its lanthanum modified compositions), potassium dihydrogen phosphate, guanadine aluminum sulfate hexahydrate, and triglycene sulfate, for example. The dielectric layer 54 has a dielectric constant ε that can be varied by application of an applied voltage signal across the conductive layers 52, 56. In particular, the dielectric constant ε is decreased as an amplitude of the voltage signal being applied across the conductive layers 52, 56 is increased. The index of refraction of the filter assembly 50 is related to the dielectric constants by the following equation:
n=ε^{1/2}
where “n” is the index of refraction of the dielectric layer 54. Thus, by varying the dielectric constant ε, the electromagnetic radiation filtering properties of the filter assembly 50 can be adjusted. For example, the dielectric constant ε can be adjusted such that electromagnetic radiation having a first wavelength either: (i) propagates through the conductive layer 52, (ii) is absorbed as heat energy by the conductive layer 52, (iii) or is reflected by the conductive layer 52. It should be noted that each filter assembly 50 in the filter array 14 is individually electrically coupled to the filter controller 16 for individual control of each filter assembly 50.

The filter controller 16 is provided to generate voltage signals for controlling operation of each filter device 50 in the filter array 14. The filter controller 16 includes an internal voltage source 17 for generating the voltage signals. The voltage source 17 is electrically coupled to each filter device 50 of the filter array 14 using distinct conductive lines. For example, the voltage source 17 is electric coupled via the conductive lines 70, 72 to the conductive layers 52, 56, respectively of one of the filter devices. Further, the voltage source 17 is configured to generate a plurality of different types of voltage signals including DC voltage signals at a plurality of voltage levels, AC voltage signals, pulse-width modulation signals, and other types of voltage signals known to those skilled in the art, based upon desired electromagnetic radiation filtering characteristics of the filter array 14.

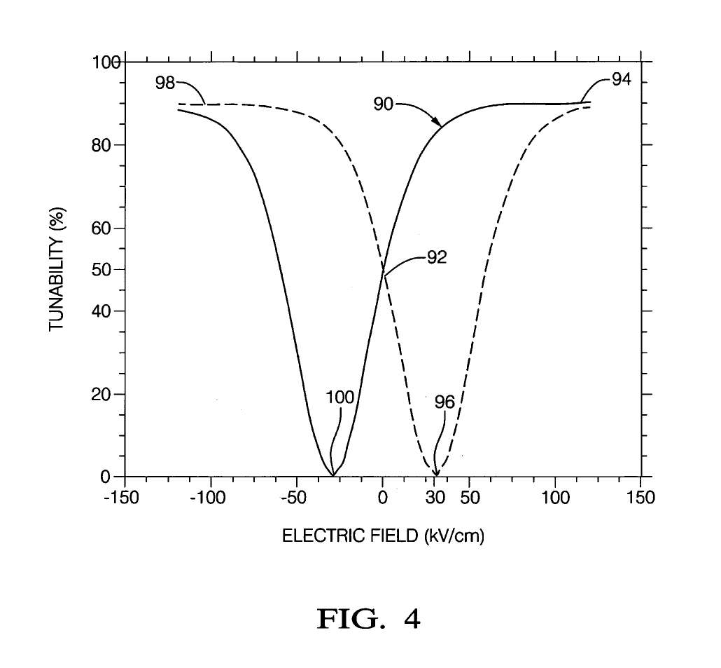

Referring to FIG. 4, a graph of a tunability curve 94 indicating operational characteristics of the filter assembly 50 in the filter array 14 is provided. For purposes of discussion, the tunability parameter on the y-axis of the graph is determined by the following equation:
Tunability=(100*Δdielectric constant/dielectric constant at a reference voltage);
where Δdielectric constant corresponds to a change in the dielectric constant ε in response to a change in the voltage signal applied to the filter assembly 50. The x-axis of the graph corresponds to the electric field applied to the filter assembly 50 by the voltage source 17. The tunability curve 94 has a point 92 when the electric field has value equal to 0 kV/cm. When the electric field is increased to 100 kV/cm, the tunability curve 94 increases from the point 92 to a point 94, indicating the dielectric constants of the filter assembly 50 has decreased. Thereafter, when the electric field is decreased to 30 kV/cm, the tunability curve 94 decreases from the point 94 to the point 96, indicating that the dielectric constants of filter assembly 50 has increased from its 100 kV/cm value. Thereafter, when the electric field is increased to 100 kV/cm, the curve 94 increases from the point 96 to the point 98, indicating that the dielectric constants of the filter assembly 50 has decreased. Thereafter, when the electric field is decreased to −30 kV/cm, the tunability curve 94 decreases from the point 98 to the point 100, indicating that the dielectric constants of the filter assembly 50 has increased.

Referring again to FIG. 1, the image processor 20 is operably coupled to the focal plane array 12. The image processor 20 is provided to generate data corresponding to a digital image based upon the FPA signal received from the focal plane array 12.

The filter assembly 50 and the method for filtering electromagnetic radiation provide a substantial advantage over other systems and methods. In particular, the filter assembly 50 is configured to vary a dielectric constant therein for varying electromagnetic radiation filtering characteristics of the filter assembly 50.

While embodiments of the invention are described with reference to the exemplary embodiments, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling within the scope of the intended claims. Moreover, the use of the term's first, second, etc. does not denote any order of importance, but rather the term's first, second, etc. are used to distinguish one element from another. Furthermore, the use of the terms a, an, etc. do not denote a limitation of quantity, but rather denote the presence of at least one of the referenced items.

What is claimed is:

1. A filter assembly for filtering electromagnetic radiation, comprising:
a dielectric layer having a first side and a second side;
a first conductive layer disposed on the first side of the dielectric layer;
a second conductive layer disposed on the second side of the dielectric layer; and
a voltage source electrically coupled to the first and second conductive layers, the voltage source configured to generate a first voltage signal that adjusts a dielectric constant value of the dielectric layer to a first desired dielectric constant value to filter electromagnetic radiation impinging on the first conductive layer, the voltage source further configured to generate at least a second voltage signal that adjusts the dielectric constant value of the dielectric layer to a second desired dielectric constant value to filter electromagnetic radiation.

2. The filter assembly of claim 1, wherein the first desired dielectric constant value is greater than the second dielectric constant value.

3. The filter assembly of claim 1, wherein the first desired dielectric constant value is less than the second dielectric constant value.

4. The filter assembly of claim 1, wherein the electromagnetic radiation having a first wavelength propagates through the first conductive layer.

6. The filter assembly of claim 1, wherein the electromagnetic radiation having a first wavelength is reflected away from the first conductive layer.

7. The filter assembly of claim 1, wherein the dielectric constant value of the dielectric layer is decreased when an amplitude of the first voltage signal is increased.

8. A method for filtering electromagnetic radiation utilizing a filter assembly, the filter assembly having a dielectric layer having a first side and a second side, the filter assembly further having a first conductive layer disposed on the first side of the dielectric layer, the filter assembly further having a second conductive layer disposed on the second side of the dielectric layer, the filter assembly further having a voltage source electrically coupled to the first and second conductive layers, the method comprising:
generating a first voltage signal utilizing the voltage source that adjusts a dielectric constant value of the dielectric layer to a first desired dielectric constant value to filter electromagnetic radiation impinging on the first conductive layer; and,
generating a second voltage signal utilizing the voltage source that adjusts the dielectric constant value of the dielectric layer to a second desired dielectric constant value to filter electromagnetic radiation impinging on the first conductive layer.

9. The method of claim 8, wherein the first desired dielectric constant value is greater than the second dielectric constant value.

10. The method of claim 8, wherein the first desired dielectric constant value is less than the second dielectric constant value.

11. The method of claim 8, wherein the electromagnetic radiation having a first wavelength propagates through the first conductive layer.

12. The method of claim 8, wherein the electromagnetic radiation having a first wavelength is absorbed as heat energy by the first conductive layer.

13. The method of claim 8, wherein the electromagnetic radiation having a first wavelength is reflected away from the first conductive layer.

14. The method of claim 8, wherein the dielectric constant value of the dielectric layer is decreased when an amplitude of the first voltage signal is increased.
